(19) United States
(12) Patent Application Publication
(10) Pub. No.: US 2011/0080603 A1
(43) Pub. Date: Apr. 7, 2011

(54) Document Security System and Method for Authenticating a Document

(76) Inventors: Richard T. Horn, Claremont, CA (US); Lynn Rochelle Kirby-Mello, Pasadena, CA (US)

(21) Appl. No.: 12/572,325

(22) Filed: Oct. 2, 2009

(51) Int. Cl. G06F 3/12; G06K 9/00

(52) U.S. Cl. 358/1.13; 382/100

(57) ABSTRACT

A document security system for documents having an electronic data storage device (EDSD) includes a printing device, a first optical scanner associated with the printing device, an electronic data storage device writer, an electronic data storage device reader, and a second optical scanner associated with the electronic data storage device reader. The optical scanners detect, capture and analyze a speckle pattern on a scanned surface of a page of the document and transmits page data related to the speckle pattern of each page of the document. The documents are marked by scanning each page of an unmarked document with the first optical scanner and storing the page data for each page of the document on the document EDSD. The document is verified by scanning each page of a marked document with the second optical scanner, reading the page data stored in the document EDSD, and comparing the stored document page data to the scanned document page data.

### BACKGROUND

This disclosure relates generally to security apparatus and methods for verification of authenticity of an article. More particularly, the present disclosure relates to security apparatus and methods for verification of authenticity of a document.

Concerns with security for documents containing financial information, personal information, government information or the like require better methods for certifying such documents, and ideally, each page within the document. One method employed by some users is to manually apply a unique marking or seal to each page of the document. The document may be bound such that it is visually obvious when a page has been removed. However, the protection provided by this method may be easily circumvented for loose-leaf documents and even single stitched documents.

### SUMMARY

There is provided a document security system for documents having an electronic data storage device (EDSD) comprising a printing device and a first optical scanner associated with the printing device. The first optical scanner detects, captures and analyzes a speckle pattern on a scanned surface of a page of the document and transmits page data related to the speckle pattern of each page of the document. An electronic data storage device writer records the document page data on the document EDSD.

A computer in communication with the first optical scanner stores the page data for each page of the document in a database and transmits the document page data to the electronic data storage device writer.

The database includes a record for each document. The record includes the page data for each page of the document and the position of each page relative to each other page of the document.

The first optical scanner may be an integral component of the printing device, or the first optical scanner and the printing device may be separate devices.

The document security system further comprises an electronic data storage device reader adapted to read the document page data stored on the document EDSD and a second optical scanner associated with the electronic data storage device reader. The second optical scanner detects, captures and analyzes a speckle pattern on a scanned surface of a page of the document and transmits page data related to the speckle pattern of each page of the document. The document authenticity is verified by reading the document page data stored in the document EDSD with the EDSD reader, scanning the document pages with the second optical scanner, and comparing the stored document page data to the scanned document page data.

A computer in communication with the second optical scanner and the EDSD reader compares the stored document page data to the scanned document page data.

There is also provided a method of authenticating of a document having an electronic data storage device (EDSD) comprising marking the document by scanning each page of an unmarked document with an optical scanner that detects a speckle pattern on a scanned surface of the page and develops page data from the speckle pattern, and storing the page data for each page of the document on the document EDSD with an electronic data storage device writer. The document is verified by scanning each page of a marked document with an optical scanner that detects the speckle pattern on a scanned surface of the page and develops page data from the speckle pattern, reading the page data stored in the document EDSD, and comparing the stored document page data to the scanned document page data.

The method further comprises transmitting the document page data of the unmarked document from the optical scanner to a computer. The computer accumulates the document page data for each page of the unmarked document and stores the document page data in a database.

Each page of the unmarked document may be scanned by the optical scanner as the page is printed.

The unmarked document may be scanned by the optical scanner when the document is printed.

The method further comprises transmitting the document page data of the marked document from the optical scanner to a computer, accumulating the document page data for each page of the marked document in the computer, and comparing the stored document page data to the scanned document page data in the computer.

The computer generates a message that the marked document is authentic if the stored document page data matches the scanned document page data.

If the stored document page data does not match the scanned document page data, the computer may generate a message the marked document is not authentic, that one or more pages are missing from the marked document or have been added to the marked document, or that the pages of the marked document are out of sequence.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of a document security system in accordance with the present disclosure; and

FIG. 2 is a flow diagram of the method for authenticating a document;

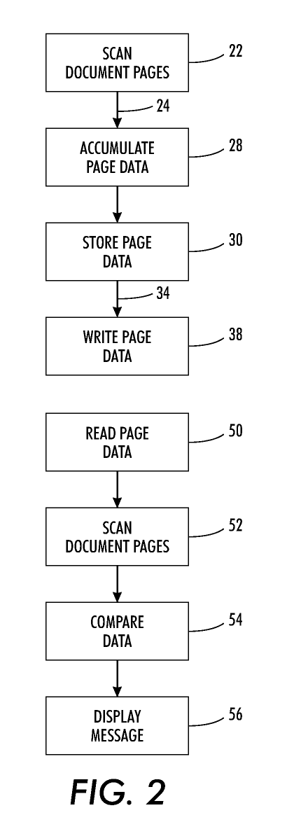

### DETAILED DESCRIPTION

With reference to the drawings wherein like numerals represent like parts throughout the several figures, a document security system and method for verification of authenticity of a document in accordance with the present disclosure is generally designated by the numeral 10. The subject security system 10 and method does not apply to “virtual” documents such as electronic data files.

The security system 10 includes an optical scanner 12 capable of detecting, capturing and analyzing the speckle pattern that is present on the surface of paper sheets 14. It has been established that this pattern is caused by the unique structure of the fiber arrangement in the page at a microscopic level. Since the fiber arrangement is random, the speckle pattern is unique for each paper sheet 14. It has also been established the speckle pattern is very robust and almost impervious to printing on the paper, minor crumpling, or even minor water damage. Optical scanners 12 having this capability conventionally shine a coherent light beam on the surface of the paper sheet 14 and detect the reflected speckle pattern. These scanners 12 have the capability of capturing and analyzing the reflected speckle pattern and establishing a unique identification description. Due to the robust properties of the speckle pattern, markings appearing on the surface of the paper sheet 14 may be distinguished from the speckle pattern and eliminated from the identification description.

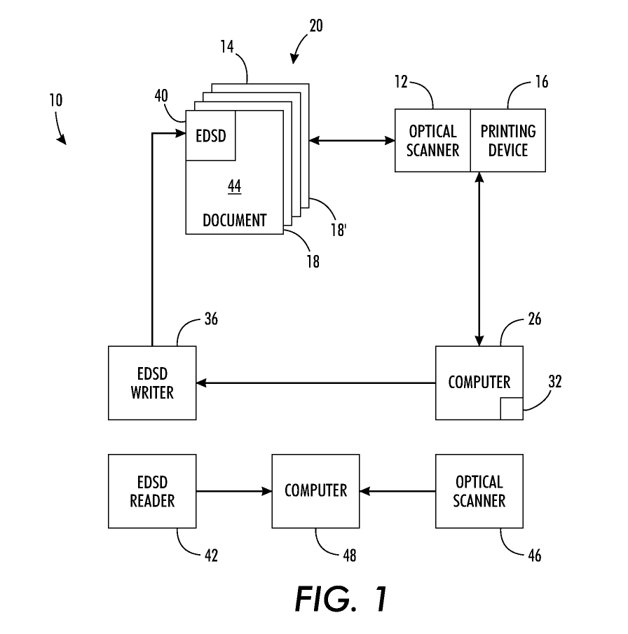

In the security system 10 shown in FIG. 1, the optical scanner 12 is associated with a printing device 16, wherein each page 18 printed by the printing device 16 may be scanned by the optical scanner 12. It should be appreciated that the optical scanner 12 may be an integral component of the printing device 16 such that the scanning process and printing process are performed concurrently or consecutively as each page 18 passes through the combined device. In one alternative, the optical scanner 12 and printing device 16 are separate devices with the scanning process being performed on each paper sheet 14 either before or after the printing process. In another alternative, the optical scanner 12 and printing device 16 are separate devices with the scanning process being performed on all of the paper sheets 14 either before or after the entire document 20 is printed.

The optical scanner 12 detects, captures and analyzes the speckle pattern on the surface of the paper sheet 14 that is scanned 22 and transmits 24 this page data to a computer 26. The computer 26 accumulates 28 the page data for each page 18 of the document 20 and stores 30 the document page data in a database 32. The database 32 may include a record for each document containing the document page data or a set of linked records for each page 18 of the document 20. The document page data may include a unique identifier for each page 18, the page data for each page 18, and the position of each page 18 relative to the other pages 18′ of the document 20. The computer 26 transmits 34 the document page data to an electronic data storage device writer 36 that records 38 the document page data on an electronic data storage device 40 (EDSD) disposed in the document 20. The page data may be stored in the EDSD 40 as the document 20 is printed or at the end of the print process. The document page data may be encrypted if desired.

An “electronic data storage device” 40 is a machine-writeable and machine-readable device capable of storing electronic data. Electronic data storage device 40 refers to a single electronic data storage device as well as a collection of two or more electronic data storage devices connected, for example, in series, in parallel, or nested one within another. Examples of electronic data storage devices 40 include, but are not limited to, radio frequency identification tags (RFID tags), proximity (Prox) tags, iButtons, smartcards, and similar devices.

The EDSD 40 may be affixed to the document 20 in a conventional manner such that a EDSD writer 36 may program/write data into the EDSD 40 and a EDSD reader 42 may detect the EDSD 40 and read data stored in the EDSD 40. For EDSDs 40 that require line-of-sight or otherwise require close proximity for detection and reading/writing, the EDSD 40 may be mounted to the cover 44 of the document 20. For EDSDs 40 that do not require line-of-sight or may be detected and read/programmed at a distance, the EDSD 40 may be affixed to an inner page 18′ of the document 20.

The authenticity of a document 20 may be easily verified at the page level at any later time using an EDSD reader 42 and an optical scanner 46 connected to a computer 48. It should be appreciated that the EDSD reader 42, optical scanner 46 and computer 48 may comprise an integral device, and may be either handheld or stationary. The document authenticity is verified by reading 50 the document page data stored in the document EDSD 40 with the EDSD reader 42 and scanning 52 the document pages 18 with the optical scanner 46. The stored document page data and the scanned document page data are then compared 54 by the computer 48. The document is authentic if the stored document page data matches the scanned document page data. If the stored document page data does not match the scanned document page data, the computer may generate 56 a message simply stating that the document is not authentic. Alternatively, the computer may generate 56 a message stating that one or more pages are missing from the document or have been added to the document. If the stored document page data includes the relative position of each page in the document, the computer can also determine if the document pages are out of sequence and generate 56 a message to that effect.

A separate database of identification information may be maintained on computer 26 for use by the user for process control and overall verification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A document security system for documents having an electronic data storage device (EDSD) comprises:
a printing device;
a first optical scanner associated with the printing device, the first optical scanner detecting, capturing and analyzing a speckle pattern on a scanned surface of a page of the document and transmitting page data related substantially solely to the speckle pattern of each page of the document; and
an electronic data storage device writer adapted to record the document page data on the document EDSD.

2. The document security system of claim 1 further comprising a computer in communication with the first optical scanner and the electronic data storage device writer, the computer storing the page data for each page of the document in a database and transmitting the document page data to the electronic data storage device writer.

3. The document security system of claim 2 wherein the database includes a record for each document, the record including the page data for each page of the document and the position of each page relative to each other page of the document.

4. The document security system of claim 1 wherein the first optical scanner is an integral component of the printing device.

5. The document security system of claim 1 wherein the first optical scanner and the printing device are separate devices.

6. The document security system of claim 1 further comprising:
an electronic data storage device reader adapted to read the document page data stored on the document EDSD; and
a second optical scanner associated with the electronic data storage device reader, the second optical scanner detecting, capturing and analyzing a speckle pattern on a scanned surface of a page of the document and transmitting page data related to the speckle pattern of each page of the document;
wherein the document authenticity is verified by reading the document page data stored in the document EDSD with the EDSD reader, scanning the document pages with the second optical scanner, and comparing the stored document page data to the scanned document page data.

7. The document security system of claim 6 further comprising a computer in communication with the second optical scanner and the electronic data storage device reader, the computer comparing the stored document page data to the scanned document page data.

8. The document security system of claim 7 wherein the computer in communication with the second optical scanner and the electronic data storage device reader includes a database having the document page data stored therein.

9. A document security system for documents having an electronic data storage device (EDSD) comprises:
a printing subsystem including
a printing device,
an optical scanner, the optical scanner detecting, capturing and analyzing a speckle pattern on a scanned surface of a page of the document and transmitting page data related substantially solely to the speckle pattern of each page of the document,
a computer in communication with the optical scanner, and
an electronic data storage device writer in communication with the computer, the electronic data storage device writer being adapted to record the document page data on the document EDSD; and
a verification subsystem including
an electronic data storage device reader adapted to read the document page data stored on the document EDSD,
a computer in communication with the optical scanner, and
an optical scanner in communication with the computer, the optical scanner detecting, capturing and analyzing a speckle pattern on a scanned surface of a page of the document and transmitting page data related to the speckle pattern of each page of the document;
wherein the document authenticity is verified by reading the document page data stored in the document EDSD with the EDSD reader, scanning the document pages with the verification subsystem optical scanner, and comparing the stored document page data to the scanned document page data in the verification subsystem computer.

10. The document security system of claim 9 wherein the printing subsystem computer has a database having the page data for each page of the document stored therein.

11. The document security system of claim 2 wherein the verification subsystem computer has a database having the document page data stored therein.

12. A method of authenticating of a document having an electronic data storage device (EDSD) comprises:
marking the document by
scanning each page of an unmarked document with an optical scanner that detects a speckle pattern on a scanned surface of the page and develops page data from the speckle pattern, and
storing the page data for each page of the document on the document EDSD with an electronic data storage device writer;
verifying the document by
scanning each page of a marked document with an optical scanner that detects the speckle pattern on a scanned surface of the page and develops page data from the speckle pattern,
reading the page data stored in the document EDSD, and
comparing the stored document page data to the scanned document page data.

13. The method of claim 12 further comprising:
transmitting the document page data of the unmarked document from the optical scanner to a computer;
accumulating the document page data for each page of the unmarked document in the computer; and
storing the document page data in a database on the computer.

14. The method of claim 13 further comprising transmitting the document page data from the computer to the electronic data storage device writer.

15. The method of claim 12 wherein each page of the unmarked document is scanned by the optical scanner as the page is printed.

16. The method of claim 12 wherein the unmarked document is scanned by the optical scanner when the document is printed.

17. The method of claim 12 further comprising:
transmitting the document page data of the marked document from the optical scanner to a computer;
accumulating the document page data for each page of the marked document in the computer; and
comparing the stored document page data to the scanned document page data in the computer.

18. The method of claim 17 further comprising generating a message with the computer that the marked document is authentic if the stored document page data matches the scanned document page data.

19. The method of claim 17 further comprising generating a message with the computer that the marked document is not authentic if the stored document page data does not match the scanned document page data.

20. The method of claim 17 further comprising generating a message with the computer stating that one or more pages are missing from the marked document or have been added to the marked document if the stored document page data does not match the scanned document page data.

21. The method of claim 17 further comprising generating a message with the computer that the pages of the marked document are out of sequence if the stored document page data does not match the scanned document page data.
